(19) United States
(12) Patent Application Publication
(10) Pub. No.: US 2023/0415457 A1
(43) Pub. Date: Dec. 28, 2023

(54) GLASS LAMINATES CONTAINING LOW EXPANSION GLASS

(71) Applicant: CORNING INCORPORATED, CORNING, NY (US)

(72) Inventors: James Gregory Couillard, Ithaca, NY (US); Michael Aaron McDonald, Painted Post, NY (US)

(21) Appl. No.: 18/037,804

(22) PCT Filed: Nov. 19, 2021
(86) PCT No.: PCT/US2021/060065

§ 371 Date: May 19, 2023

Related U.S. Application Data
(60) Provisional application No. 63/118,246, filed on Nov. 25, 2020.

(51) Int. Cl. B32B 17/10; B32B 7/027; B32B 3/08

(52) U.S. Cl. CPC B32B 17/101; B32B 7/027; B32B 17/10036; B32B 17/10119; B32B 3/08; B32B 17/10935; B32B 17/10972; B32B 17/10091; B32B 17/10761; B32B 2307/30; B32B 2307/7376; B32B 2250/40; B32B 2305/72; B32B 2309/02; B32B 2309/105; B32B 2315/08; B32B 2329/06; B32B 2419/00; E06B 3/54

(57) ABSTRACT

Apparatus and related methods are provided for a laminate glass article, comprising: a first layer of a first material, the first sheet having a thickness less than 2 mm and a first coefficient of thermal expansion (CTE) measured over a range of from 0-300° C.; a second layer of a second material, the second sheet having a thickness greater than 2 mm and a second CTE greater than the first CTE; and a polymer interlayer between the first and second layers, wherein the first glass sheet has a surface compressive stress greater than 4 MPa.

### CROSS-REFERENCE TO RELATED APPLICATIONS

This application claims the benefit of priority under 35 U.S.C. § 119 of U.S. Provisional Application No. 63/118,246, filed Nov. 25, 2020, the content of which is incorporated herein by reference in its entirety.

### FIELD OF THE INVENTION

Generally, the present disclosure relates to various embodiments of a laminate comprising a multi-layer assembly having a compressive stress configured during lamination to provide an improved performance in the glass laminate article.

### BACKGROUND

Some applications of laminate structures include automotive and architectural windows made from glass sheets. In these applications, the glass panes are of similar thickness and composition. The glass used in these constructions can be several millimeters thick, resulting in excessive weight of the overall window.

### SUMMARY OF THE INVENTION

One issue with the previous approach is that laminates containing thin glass plies may not be as resistant to static loads as laminates containing thin glasses. Glass below 2 mm in thickness cannot be heat strengthened or tempered to increase strength (as defined by ASTM C1048). Chemical strengthening is only possible for alkali-containing compositions and adds significant process cost and complexity. If the thicker plies in the laminate are heat strengthened or tempered, then the thin ply can become the limiting factor for overall load resistance of the laminate. Architectural windows may be required to withstand high winds and snow loads depending on their size and location.

One or more embodiments of the present disclosure are generally directed towards laminate structures wherein two or more layers with different material properties such as thermal expansion coefficient and/or thickness, where the layers are joined using a viscoelastic adhesive interlayer. Thin fusion glass can be used to replace one of the glass plies, thereby reducing weight of the laminate article.

One or more embodiments of the present disclosure, a low-expansion glass is utilized as the thin ply of the laminate, in order to develop compressive stress during the lamination process, and thus increase load to failure. This method was applied to create glass-glass laminates with polyvinyl butyral (PVB) interlayers, however it could be applied to other interlayer material systems, as disclosed herein.

In some embodiments, the process starts with flat sheets of dissimilar materials, such as those having differing coefficients of thermal expansion (CTE). The sheets are laminated to adhere an interlayer between the sheets, thus creating a glass laminate article. Without being bound to any particular mechanism and/or theory, it is believed that because the adhesive interlayer is cured at elevated temperature (e.g. 100˜150° C.), the difference in thermal expansion between the two materials will result in uniform biaxial stress when the structure is cooled (e.g. annealed) to room temperature. The first glass sheet, the low expansion ply, will thus be configured under compressive stress, and will therefore able to withstand higher surface stresses (e.g. from higher applied loads) before breakage than unstrengthened glass (e.g. glass having the same thickness and composition, but without such compressive stress configuration).

Thin glass (≤2 mm) cannot be heat strengthened or tempered to increase strength (as defined by ASTM C1048). Chemical strengthening is not possible for alkali-free compositions, which are desirable for their higher visible light transmission, and adds significant process cost and complexity.

In one aspect, a laminate glass article is provided, comprising: a first layer of a first transparent or translucent material, the first sheet having a thickness less than 2 mm and a first coefficient of thermal expansion (CTE) measured over a range of from 0-300° C.; a second layer of a second transparent or translucent material, the second sheet having a thickness greater than 2 mm and a second CTE greater than the first CTE; and a polymer interlayer positioned between the first layer and the second layer and configured to attach the first layer to the second layer, wherein the first glass sheet has a surface compressive stress greater than 4 MPa.

In some embodiments, the polymer interlayer comprises: a polyvinyl alcohol (PVA), a polyvinyl butyral (PVB), an ethylene-vinyl acetate (EVA), an ionomer, a polyvinyl acetal, or a thermoplastic polyurethanes (TPU).

In some embodiments, the first CTE is less than 60×10⁻⁷/° C.

In some embodiments, the second CTE is greater than 75×10⁻⁷/° C.

In some embodiments, the first glass sheet is an alkaline earth boro-aluminosilicate glass.

In some embodiments, the second glass sheet is a soda lime silicate glass.

In some embodiments, the second glass sheet has a thickness of 2 mm to not greater than 6 mm.

In some embodiments, the first glass sheet has a thickness of 2 mm to not less than 0.5 mm.

In some embodiments, the interlayer has a thickness of 0.5 mm to not greater than 3 mm.

In one aspect, a fenestration product is provided, comprising: a glass laminate article having: a first layer of a first transparent or translucent material, the first sheet having a thickness less than 2 mm and a first coefficient of thermal expansion (CTE) measured over a range of from 0-300° C.; a second layer of a second transparent or translucent material, the second sheet having a thickness greater than 2 mm and a second CTE greater than the first CTE; and a polymer interlayer between the first layer and the second layer; and a frame supporting the laminate edges in a plane, wherein, via the frame, the first glass sheet of the glass laminate article has an increased surface compressive stress when mounted in the frame than when unmounted.

In some embodiments, the frame is configured with a seal member, wherein the seal is configured to provide compressive engagement to the edge of the laminate structure.

In some embodiments, the frame is configured to retain the glass laminate article in restrictive engagement to retain the compressive stress on the first layer.

In some embodiments, the fenestration product comprises a fenestration product.

In some embodiments, the fenestration product comprises a linear area of 4 feet by 8 feet.

In some embodiments, the fenestration product comprises a linear area of 8 feet by 10 feet.

In some embodiments, the fenestration product comprises a linear area of 10 feet by 12 feet.

In some embodiments, the fenestration product is configured as: a window, a door, a curtain wall, a skylight, or a roof window.

In some embodiments, the fenestration product comprises a safety glazing, when measured in accordance with: ANSI Z97.1 or EN 12600 standards.

In one aspect, a method is provided, comprising: assembling laminate component layers into a stack, wherein the component layers include: a first layer of a first transparent or translucent material, the first sheet having a thickness less than 2 mm and a first coefficient of thermal expansion (CTE) measured over a range of from 0-300° C.; a second layer of a second transparent or translucent material, the second sheet having a thickness greater than 2 mm and a second CTE greater than the first CTE; and a polymer interlayer positioned between the first layer and the second layer and configured to attach the first layer to the second layer, removing any entrapped air from the stack to make curable stack; and curing the curable stack to make a glass laminate article, wherein the first glass sheet has a surface compressive stress greater than 4 MPa.

In some embodiments, curing comprises laminating at a temperature sufficient to enable the polymer interlayer to cure, thus bonding the first layer to the second layer.

In some embodiments, the glass laminate article is configured as a safety glazing, when measured in accordance with: ANSI Z97.1 or EN 12600 standards.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings:

FIG. 1 depicts a plot of measured and modeled stress on boro-aluminosilicate glass in a laminate, where the compressive stress is attributed to the lamination process, in accordance with one or more embodiments of the present disclosure.

FIG. 2 depicts the results of computer modeled finite element modeled stress on the boro-aluminosilicate glass, when configured in a 4 foot×8 foot laminate, where the compressive stress is attributed to the lamination process, in accordance with one or more embodiments of the present disclosure.

FIG. 3 depicts the results of computer modeled finite element analysis, depicting the modeled stress on boro-aluminosilicate glass in a 4 foot×8 foot laminate with the edges fixed in a plane, in accordance with one or more embodiments of the present disclosure.

FIG. 4A through FIG. 4D depict schematic cut-away side views of the glass laminate article and IGU having a glass laminate article, frame, and coating(s), in accordance with one or more embodiments of the present disclosure.

FIG. 5 depicts a flow chart of an embodiment of a lamination process employable to place the boro-aluminosilicate glass into compression when configured in a laminate with an interlayer bonding the boro-aluminosilicate glass layer to a second glass layer having a different thickness and different CTE, in accordance with one or more embodiments of the present disclosure.

### DETAILED DESCRIPTION OF THE DRAWINGS

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

### Example

Experimentally, 12 inch×12 inch laminates were made from 4.76 mm heat strengthened soda lime glass (SLG) (second layer) and 0.7 mm boro-aluminosilicate glass (first layer). The stress in the first layer was then measured using a SCALP instrument [https://www.glasstress.com/web/]. When the lamination foil between the two glasses was 90 mil SentryGlas® the exposed first layer surface had an average stress of 4.35 MPa (compressive). For a 90 mil PVB (Trosifol® Clear) foil, which transmits less stress to the first layer surface, the surface stress was 3.2 MPa. (1 mil=0.001 inch=0.0254 mm, thus 90 mil=2.29 mm.)

Without being bound by any particular mechanism and/or theory, the first layer's compressive stress in laminate form is believed to be attributable to the difference between the coefficient of thermal expansion of boro-silicate glass (the first layer) (e.g. which is approximately 32×10⁻⁷/K) and the coefficient of thermal expansion of SLG (the second layer (e.g. which is approximately 90×10⁻⁷/K). The two stacks of laminate components were laminated at temperatures above 100° C. and cooled to room temperature. Upon cooling, the second layer SLG will contract more than the boro-aluminosilicate glass, with the resulting process-induced stresses putting the boro-aluminosilicate glass into compression when retained in laminate form.

For comparison, when the second layer of boro-aluminosilicate glass is replaced with 0.7 mm SLG (comparative example second layer), the resulting laminate of similar CTE glasses (first layer and comparative example second layer) has <1 MPa compressive stress in the thin ply. However, it is noted that this is within the measurement error for a stress-free part.

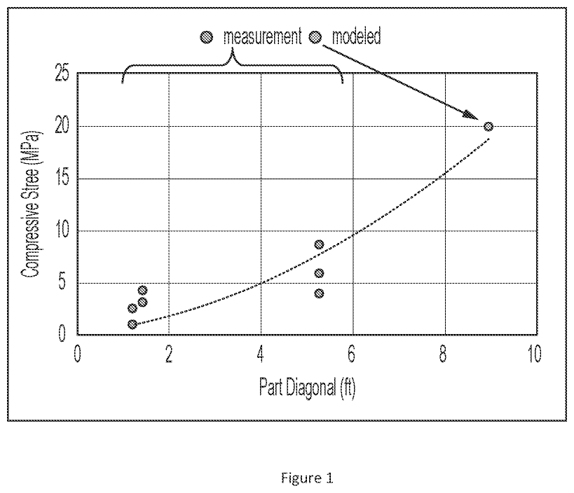

Measurements of other parts, and finite element simulation of larger parts, are shown in FIG. 1. Referring to FIG. 1, the surface compression appears to increase with glass laminate size. At around 4 foot×8 foot size, the modeled compressive stress is around 20 MPa, and can be as high as 25 MPa, which is comparable to the stress of heat strengthened thick SLG (≥24 MPa per ASTM C1048).

In addition to putting the thin glass ply under compression, the difference in expansion results in spherical out-of-plane distortion, or bow, in the laminate. The compressive stress on the second layer, thin glass ply, can therefore be further increased by mechanically flattening the laminate. As shown in FIG. 1, 989 mm×1256 mm laminates (first layer 4.76 mm SLG/interlayer 105 mil SentryGlas/second layer 0.7 mm boro-aluminosilicate) were measured to have 4˜9 MPa surface compression, as measured in the (outer-facing) surface of the second layer. (105 mil=2.67 mm thickness interlayer.)

After mechanically flattening the laminate glass article by applying pressure at the panel center, the compression measured in the (outer-facing) surface of the second layer increased to 17˜24 MPa. This further increases the potential load resistance of the laminate, while having the added benefit of reducing optical distortion, a desirable attribute in a fenestration product with architectural applications and/or other products.

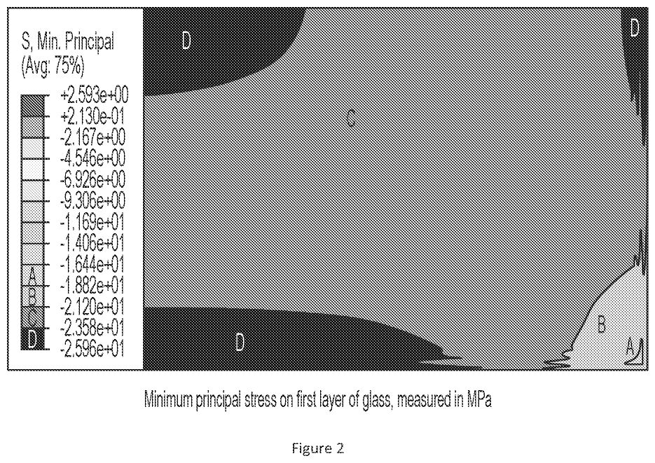

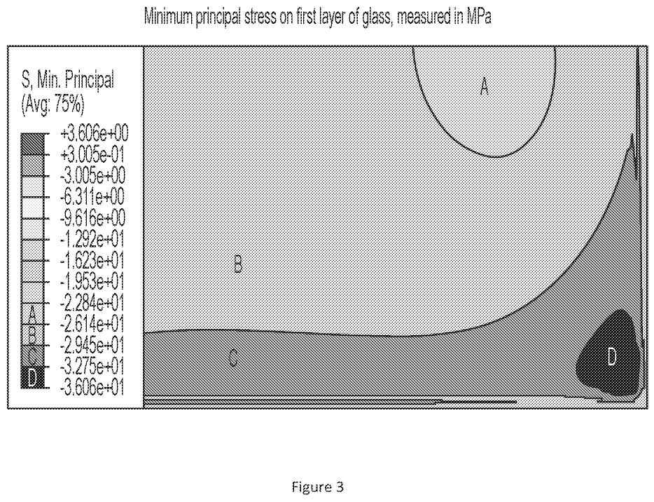

In practice, the flattening can be achieved by mounting the glass laminate article laminate in a frame (e.g. configuring the glass laminate article in a frame, and providing restrictive engagement to the glass laminate article via the frame for a fenestration application). Confining the edges of the glass laminate article to a plane, via the frame (with an optional seal member) has the effect of reducing overall bow and hence increasing compressive stress in the second layer (e.g. thin ply). FIG. 3 shows modeling of the 4 foot×8 foot laminate of FIG. 2 after requiring the laminate edges have minimal deflection. The compressive stress, as measured in the (outer-facing) surface of the second layer, increases from 20˜25 MPa to 25˜36 MPa.

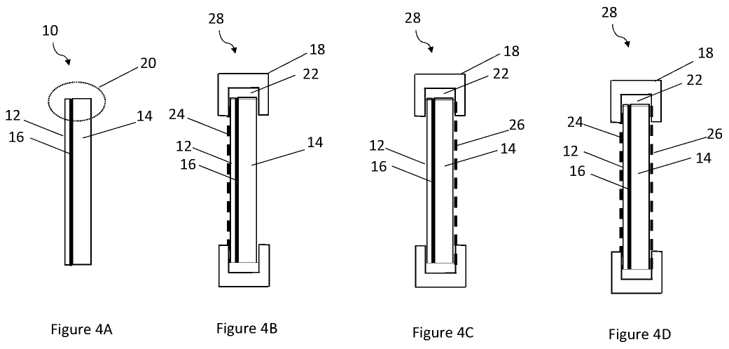

FIGS. 4A-4D depicts various embodiments of the glass laminate article and fenestration product, in accordance with one or more aspects of the present disclosure.

Referring to FIG. 4A, a glass laminate article 10 is depicted. The glass laminate article 10 includes a first layer 12, a second layer 14, and an interlayer 16, configured between the first layer 12 and second layer 14 and attaching/adhering the two together to form the laminate glass article 10. Also, the edge(s) 20 are denoted.

Referring to FIG. 4B, the glass laminate article 10 of FIG. 4A is depicted in a window configuration, shown as 28. The glass laminate article 10 includes a frame 18 configured around the edges of the laminate article 10, with a seal member 22 positioned between the frame 18 and the edge 20 to promote compressive engagement and/or retention in a plane configuration. FIG. 4B depicts a second coating 24 on the outer surface of the first layer 12.

Referring to FIG. 4C, the glass laminate article 10 of FIG. 4A is depicted in a window configuration, shown as 28. The glass laminate article 10 includes a frame 18 configured around the edges of the laminate article 10, with a seal member 22 positioned between the frame 18 and the edge 20 to promote compressive engagement and/or retention in a plane configuration. FIG. 4C depicts a first coating 26 on the outer surface of the second layer 14.

Referring to FIG. 4D, the glass laminate article 10 of FIG. 4A is depicted in a window configuration, shown as 28. The glass laminate article 10 includes a frame 18 configured around the edges of the laminate article 10, with a seal member 22 positioned between the frame 18 and the edge 20 to promote compressive engagement and/or retention in a plane configuration. FIG. 4D depicts a first coating 26 on the outer surface of the second layer 14 and a second coating 24 on the outer surface of the first layer 12.

As some non-limiting examples, the coating includes: a low emissivity coating, an anti-reflective coating; a tint coating; an easy clean coating; or an anti-bird strike coating. In some embodiments, the coating is a partial coating. In some embodiments, the coating is a full coating. In some embodiments (e.g. anti-bird strike coating), the coating is patterned along discrete portions of the surface.

For example, the low emissivity coating can be comprised of a combination of metals and oxides, including non-limiting examples of silicon nitride, metallic silver, silicon dioxide, tin oxide, zirconium oxide, and/or combinations thereof, to name a few.

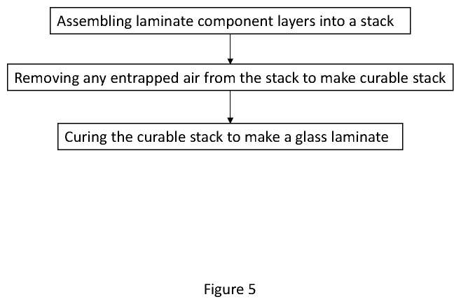

FIG. 5 depicts a method of making a glass laminate article. As shown, the lamination process includes assembling the laminate component layers into a stack. The various component layers, including a first layer, an interlayer, and a second layer, are placed into contact with one another to form the stack.

Next, the lamination process includes removing any entrapped or entrained air between the various layers of the stack to form a curable stack. Non-limiting examples of air removal include: nip rolling, using an evacuation pouch, vacuuming via at least one vacuum ring, or a laminating via a flatbed laminator.

Lamination includes the following steps: raising the temperature of the stack to an elevated temperature (sufficient to cure the stack); curing the stack to adhere the first layer to the second layer via the interlayer, thus forming a laminated glass article; and cooling the laminated glass article to near room temperature.

Many variations and modifications may be made to the above-described embodiments of the disclosure without departing substantially from the spirit and various principles of the disclosure. All such modifications and variations are intended to be included herein within the scope of this disclosure and protected by the following claims.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. As a non-limiting example, about means less than 10% of the referenced value.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

1. A laminate glass article, comprising:
a. a first layer of a first transparent or translucent material, the first sheet having a thickness less than 2 mm and a first coefficient of thermal expansion (CTE) measured over a range of from 0-300° C.;
b. a second layer of a second transparent or translucent material, the second sheet having a thickness greater than 2 mm and a second CTE greater than the first CTE; and
c. a polymer interlayer positioned between the first layer and the second layer and configured to attach the first layer to the second layer,
d. wherein the first glass sheet has a surface compressive stress greater than 4 MPa.

2. The laminate of claim 1, wherein the polymer interlayer comprises: a polyvinyl alcohol (PVA), a polyvinyl butyral (PVB), an ethylene-vinyl acetate (EVA), an ionomer, a polyvinyl acetal, or a thermoplastic polyurethanes (TPU).

3. The laminate of claim 1, wherein the first CTE is less than 60×10-7/° C.

4. The laminate of claim 1, wherein the second CTE is greater than 75×10-7/° C.

5. The laminate of claim 1, wherein the first glass sheet is an alkaline earth boro-aluminosilicate glass.

6. The laminate of claim 1, wherein the second glass sheet is a soda lime silicate glass.

7. The laminate of claim 1, wherein the second glass sheet has a thickness of 2 mm to not greater than 6 mm.

8. The laminate of claim 1, wherein the first glass sheet has a thickness of 2 mm to not less than 0.5 mm.

9. A fenestration product, comprising:
a. a glass laminate article having:
i. a first layer of a first transparent or translucent material, the first sheet having a thickness less than 2 mm and a first coefficient of thermal expansion (CTE) measured over a range of from 0-300° C.;
ii. a second layer of a second transparent or translucent material, the second sheet having a thickness greater than 2 mm and a second CTE greater than the first CTE; and
iii. a polymer interlayer between the first layer and the second layer; and
b. a frame supporting the laminate edges in a plane,
c. wherein, via the frame, the first glass sheet of the glass laminate article has an increased surface compressive stress when mounted in the frame than when unmounted.

10. The fenestration product of claim 9, wherein the frame is configured with a seal member, wherein the seal is configured to provide compressive engagement to the edge of the laminate structure.

11. The fenestration product of claim 9, wherein the frame is configured to retain the glass laminate article in restrictive engagement to retain the compressive stress on the first layer.

12. The fenestration product of claim 9, wherein the interlayer is configured with a thickness of 0.5 mm to not greater than 2.9 mm thick.

13. The fenestration product of claim 9, wherein the fenestration product comprises a linear area of 4 feet by 8 feet.

14. The fenestration product of claim 9, wherein the fenestration product comprises a linear area of 8 feet by 10 feet.

15. The fenestration product of claim 9, wherein the fenestration product comprises a linear area of 10 feet by 12 feet.

16. The fenestration product of claim 1, wherein the fenestration product is configured as: a window, a door, a curtain wall, a skylight, or a roof window.

17. The fenestration product of claim 1, wherein the fenestration product comprises a safety glazing, when measured in accordance with: ANSI Z97.1 or EN 12600 standards.

18. A method, comprising:
a. assembling laminate component layers into a stack, wherein the component layers include:
b. a first layer of a first transparent or translucent material, the first sheet having a thickness less than 2 mm and a first coefficient of thermal expansion (CTE) measured over a range of from 0-300° C.;
c. a second layer of a second transparent or translucent material, the second sheet having a thickness greater than 2 mm and a second CTE greater than the first CTE; and
d. a polymer interlayer positioned between the first layer and the second layer and configured to attach the first layer to the second layer,
e. removing any entrapped air from the stack to make curable stack; and
f. curing the curable stack to make a glass laminate article, wherein the first glass sheet has a surface compressive stress greater than 4 MPa.

19. The method of claim 18, wherein curing comprises laminating at a temperature sufficient to enable the polymer interlayer to cure, thus bonding the first layer to the second layer.

20. The method of claim 18, wherein the glass laminate article is configured as a safety glazing, when measured in accordance with: ANSI Z97.1 or EN 12600 standards.
